(19) United States
(12) Patent Application Publication
(10) Pub. No.: US 2008/0077469 A1
(43) Pub. Date: Mar. 27, 2008

(54) Method and system for determining media exposure

(76) Inventors: Joseph C. Philport, New Canaan, CT (US); Jeffrey R. Casper, Tarrytown, NY (US); Neil Allan Eddleston, London (GB); Erwin Ephron, New York, NY (US); Tony Jarvis, Rowayton, CT (US); Steve Singer, New Canaan, CT (US)

Correspondence Address: FROMMER LAWRENCE & HAUG, 745 FIFTH AVENUE- 10TH FL., NEW YORK, NY, 10151, US

(21) Appl. No.: 11/528,977

(22) Filed: Sep. 27, 2006

(51) Int. Cl. G06F 17/30

(52) U.S. Cl. 705/10

(57) ABSTRACT

A method and system for determining a probability that a media display will be observed. The method comprises accessing a circulation quantity, which is a function of traffic volume through an associated geographic area. An opportunity quantity is calculated as a function of the circulation quantity. A likely-to-see quantity is calculated by multiplying the opportunity quantity by a predetermined coefficient. A probability that a media display will be seen is calculated by adjusting the likely-to-see-quantity by demographic data. The calculation may also use an extrapolation algorithm to determine the probability.

### BACKGROUND

1. Field of the Invention

The present invention relates generally to determining exposure to a media display. More particularly, the present invention relates to Out of Home (OOH) media displays and the probability that such displays will be seen by individuals by utilizing methods for determining a gross number of persons who pass an OOH media display and the percentage of persons who are likely to actually observe an OOH media display.

2. Background Discussion

OOH media displays typically include, for example, exterior media displays, billboards, signs and advertisements, which are posted alongside roads, interstates, highways, freeways and other paths of travel. The OOH display usually has writing and images that are sufficiently large and mounted on a structure that elevates the OOH display so that it may be seen from a person's normal course of travel. Typically a sponsor will install or lease the OOH display to post advertising content data.

A well-traveled location is desired to maximize the number of persons passing the OOH display. Additionally, the more individuals who pass and observe an OOH display will increase the effectiveness of the OOH displays.

Conventional techniques for determining exposure to media displays, such as OOH displays, typically identify individuals, or groups, that travel, or otherwise come within a particular pre-determined distance of a media display. These techniques are based, at least in part, on the assumption that an individual that happens to come within a particular distance, for example, 500 feet, of a media display, has observed the display and the content posted thereon.

For example, one conventional technique that utilizes the assumption that an individual's proximity to an OOH display results in the observation of the content of the OOH display is described in U.S. Pat. No. 6,970,131, issued to Roger D. Percy et al. This patent is directed to utilizing monitoring devices, such as GPS devices, for determining the effectiveness of various locations, such as media display locations for an intended purpose, such as media display exposure. The monitoring devices are distributed to a number of study respondents. The monitoring devices track the movements of the respondents. While various technologies may be used to track the movements of the respondents, at least some of the location tracking of the monitoring device utilize a satellite location system such as the global positioning system (“GPS”). These movements of the respondent and monitoring device at some point coincide with exposure to a number of media displays. Geo data (movement data) collected by the monitoring devices, is downloaded to a download server, for determining which media displays the respondent was exposed to. The exposure determinations are made by a post-processing server.

Another conventional technique is disclosed in U.S. Pat. No. 7,038,619 to Roger D. Percy, et al. This technique determines the effectiveness of media displays and includes employing a plurality of monitoring devices for determining the paths of travel followed by a plurality of respondents. Each of the respondents is associated with a respective monitoring device and each of the monitoring devices utilizes a satellite positioning system (“SPS”) to independently track the movement of the respondent along the path of travel followed by the respondent. Each of the monitoring devices generates geo data that represents the path of travel followed by the respondent. The tracking data is stored as geo data, which is collected from each of the monitoring devices. The geo data is analyzed to determine if the respondents have been exposed to media displays by matching the geo data that represents the paths of travel followed by the plurality of respondents with media display locations to determine the effectiveness of the media displays at the media display locations.

Unfortunately, the present state of the art is primarily directed to determining an individual's proximity to an OOH display to determine the effectiveness of the display. This approach is based on the assumption that an individual's proximity to an OOH display results in the observation of the content of the OOH display. This assumption has the drawback that it fails to consider that while a person may be relatively close in proximity to an OOH display, the same person may be distracted for a number of reasons (e.g. driving in the opposite direction or otherwise positioned), such that merely being close to the OOH display does not mean that the person observed the content of the OOH display. These methods also require a significantly large sampling of respondent survey data to produce viable and valuable results.

Therefore, the present invention provides an advancement in the state of the art by providing a method and system that determines a probability that an OOH display was observed by a person and the effectiveness of an OOH display.

### BRIEF SUMMARY OF THE INVENTION

The present invention is directed to an improved method and system that determines a gross number of people that will pass an OOH display and subsequently the percentage who will actually observe the OOH display.

Accordingly, one embodiment of the present invention relates to a method for determining a probability that a media display will be observed. The method comprises accessing a circulation quantity, which is a function of traffic volume through an associated section of traffic (e.g. count station or traffic or pedestrian passageways). An opportunity to see (OTS) quantity is calculated as a function of the circulation quantity. A likely-to-see (LTS) quantity is calculated by multiplying the opportunity quantity by a predetermined coefficient. A probability that a media display will be seen is calculated by adjusting the likely-to-see-quantity by demographic data.

Another embodiment of the present invention is directed to the above-described method. Furthermore, GPS data is utilized as a component of the demographic data. GPS data can be used as one of several components to collect demographic data.

Another embodiment of the present invention is directed to the above-described method. Furthermore, survey data is used as a component of the demographic data.

Another embodiment of the present invention is directed to the above-described method. Furthermore, GPS data, survey data and other forms of survey data are utilized as a component of the demographic data.

Effectiveness, as used in the present invention, means a quantifiable projection of the number of persons who (1) had an opportunity to see an OOH display and (2) actually observed an OOH display. The method and system of the present invention also uses a variety of data from multiple sources and integrates the respective data to produce a more reliable measure of effectiveness than state of the art methods.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 shows a diagram of a system used to implement the present invention.

FIG. 2 shows a flow chart of steps of an embodiment of the present invention.

FIG. 3 shows a flowchart of steps of another embodiment of the present invention.

### DETAILED DESCRIPTION OF THE INVENTION

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention. These and other embodiments are disclosed or are apparent from and encompassed by, the following Detailed Description.

The system and method of the present invention generates a probability that an Out Of Home (OOH) display will be seen by an individual.

The probability that an OOH display will be seen by an individual who is traveling, either as a pedestrian or in a vehicle (automobile, bus, motorcycle or train) is a function of a Daily Effective Circulation (“DEC”) quantity, which is typically derived from municipal and/or interstate transportation departments. The DEC is measured from the traffic volume, or “counts” through a particular “count station.” A count station is, for example, a portion of a roadway or other geographically determined region. Each count station typically has boundaries that define the region of the count station. The majority of counts are derived from public domain sources, e.g. Departments of Transportation (DOT's). The traffic volume, or count, is calculated based on a direction of traffic flow. The Opportunity-To-See (“OTS”) value of an individual media display is referred to as the DEC. For example, the DEC may be based on several factors, such as one half of the total traffic volume times a load factor to identify the number of persons traveling per vehicle and a percentage of time the OOH display would be visible per day. A DEC for pedestrian volume, if an OOH display is known to have pedestrian traffic, would be measured by similar methods except that no load factor would be required.

The OTS value is multiplied by a Eyes-On Adjustment (“EOA”) coefficient to generate a Likely-To-See (“LTS”) value. The LTS value is a function of the OTS value and specific additional data, such as eye movement of a passenger in a vehicle. The LTS value is then further modified by demographic data for particular individuals. OTS and LTS values for total persons are derived from processes identified above and then demographic profiles are ascribed from survey data. The demographic data may be acquired from a variety of sources, e.g. survey, questionnaire and/or a tracking device (e.g., a GPS device, satellite tracking) that monitors a path of travel of an individual. The method requires that data from these sources is combined to strengthen the demographic profiles. The method also allows for the collection and storage of specific attributes about each OOH display, such as type, size, geo-coded location and illumination and facing.

The method of the invention allows for at least three necessary reference agents: (1) assign OOH displays to one or more count stations, (2) overlay other information to calculate OTS or DEC (e.g. illumination) and (3) identify additional environmental factors and media display attributes associated with an OOH display that allow for modeling for EOA probability.

The method to overlay demographic granularity can operate under two correlations: (1) all demographic data defined is collected from a market (e.g. New York) and directly applied to displays in that market or (2) for smaller markets where travel survey data is not available, demographic data from larger markets will be modeled to the smaller markets. Other OOH media calculations, such as reach and frequency, may also be derived from the data collected through the described method of the invention.

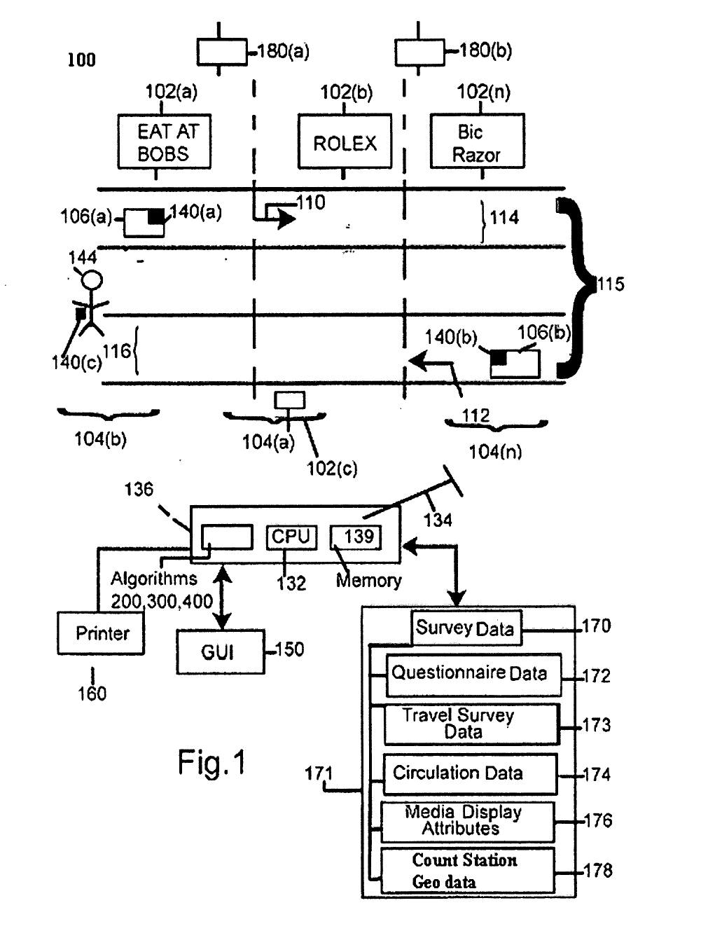

FIG. 1 shows a diagram of a system used to implement the present invention. As shown in FIG. 1, system 100 includes a plurality of OOH displays 102(a) . . . (n) (where n is any suitable number). The OOH displays, generally 102, are located along roadways, interstates, highways, city streets or virtually any location that a sponsor or OOH owner desires to place an OOH display. The OOH displays 102 typically have content on one or more surfaces. This content may be static (affixed by glue or adhesive) or dynamic (electronically programmable such that the content changes based on computer program code). As shown n FIG. 1, OOH display 102(c) has a content surface that is visible only by individuals traveling in the direction indicated by arrow 112.

One or more count stations 104(a) . . . (n) (where n is any suitable number) are identified on a portion of roadway 115. (Roadway 115 has bi directional traffic flow. A first direction 114 is indicated by arrow 110 and a second direction 116 is indicated by arrow 112.) Each count station, generally 104, is typically a designated portion of roadway 115 that is used to measure an amount of traffic volume over that portion. A quantity of traffic volume may be generated indicating the number of vehicles (automobiles, busses, etc.) 106(a) . . . (n) (where n is any suitable number) and pedestrians, including bicycles, joggers, Segway™ and other non-automobile traffic volume, shown generally in FIG. 1 as pedestrian 144.

Each OOH display 102 can be correlated with one or more count stations. Thus, as shown in FIG. 1, OOH display 102(a) is located within count station 104(b). OOH displays 102(b) and 102(c) are located within count station 104(a). OOH display 102(n) is located within count station 104(n).

The total traffic volume through a count station 104(a) . . . (n) is a representation of all traffic volume trough a particular count station. While this information bears some relationship to the OOH displays 102, it does not consider that the traffic progressing in direction 112 is unlikely to see content on OOH displays 102(a), 102(b) and 102(n). Therefore, in order to increase the accuracy of a probability that an OOH was seen by an individual, the total traffic volume data is used to generate an opportunity-to-see value (OTS). This OTS reflects that approximately half of the total traffic volume is traveling in direction 110 and half of the total traffic volume is traveling in direction 112. Statistical procedures are used to standardize counts for factors such as day of the week, seasonally, etc., so that all counts represent annual measurements.

Thus, the OTS value provides additional detail about the total traffic volume through each count station 104. However, the OTS value does not consider that a portion of the individuals traveling through a count station 104 may not actually observe the content of an OOH 102, since some portion of the individuals may be distracted, looking in another direction on the road 115, changing radio settings, speaking on a mobile telephone or engaged in other activity that prevent observation of the OOH. Further, other factors such as variation of media displays, format and size, and other environmental situations may affect the probability that a particular media display is actually observed by an individual.

Therefore, the OTS value is adjusted by an Eyes-On Adjustment (EOA) to generate a likely-to-see value (LTS). The EOA is a result of monitoring eye movements or patterns of drivers and other indicators of what individuals traveling along a portion of a roadway observe. Thus, the LTS value represents that an individual who had an opportunity to observe an OOH display did indeed view the OOH display. This LTS value may be used to extrapolate a probability that an individual observed the OOH display. The LTS is obtained by using video simulations that are administered to a sample of respondents. The simulations represent a wide variety of media displays in a wide variety of environments. Respondents' eye-tracking determines the degree to which each display is noticed. The results are then entered into a model from which EOA scores can be assigned to media displays around the country by matching their features with the features used in the simulated study.

In order to provide additional granularity and further identify characteristics of individuals who may have observed the OOH display, demographic data may be obtained from a selected portion of individuals. This demographic data may be based on GPS data, survey data, questionnaire data, mileage tracking or other data indicative of an individual's information such as age, education level, gender, income, martial status, type of vehicle and other personal information. This data is used to extrapolate, using one or more extrapolation algorithms. (Extrapolation algorithms are described in relation to FIG. 4.)

As stated above, the demographic data may be obtained using a GPS monitoring device 140(a), 140(b) and 140(c). These GPS devices can transmit data to satellites 180(a) and 180(b). This data may be transmitted to processing unit 130 through communication means 134 and 136. Communication means 134 is a wired communication means and communication means 136 is a wireless communication means.

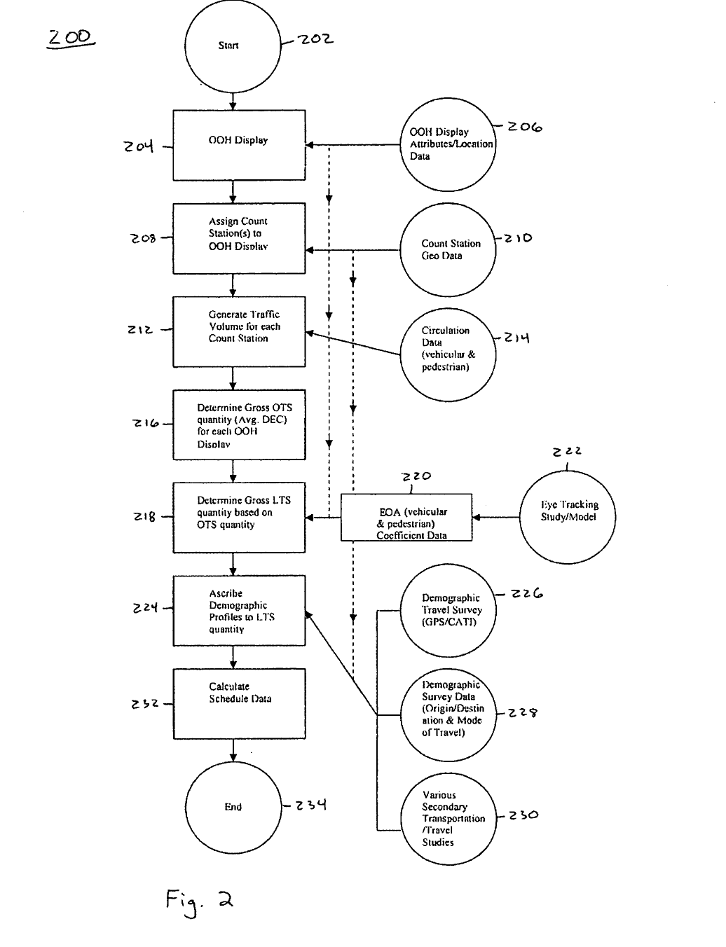

Processor unit 130 is typically a desk top computer such as includes central processing unit (CPU) 132, algorithms 200, 300, 400, and memory unit 139. While only one processor unit 130 is shown in FIG. 1, it is an embodiment of the present invention that a plurality of processing units may be used. The one or more processing units 130 may process data at various locations and/or perform parallel processing operations at a particular location. CPU 132 is typically a micro-processor with sufficient processing speed and capacity to manipulate input data. Similar to processing unit 130, it is an embodiment of the present invention that a plurality of CPUs may be used to process the data. Algorithms 200, 300 and 400 include methods and program code to perform the calculations and the extrapolation algorithm described in relation to FIGS. 2, 3 and 4. Memory unit 139 is an electronic storage unit that stores the input data and calculated data. The processor unit 130 may also include input/output units, data ports and BIOS program code as well as preprogrammed logic to implement the processing functionality.

Processor unit 130 is in bi-directional communication with database 171. Database 171 is a database that stores demographic data such as survey data 170, questionnaire data 172, travel survey (interview or GPS) data 173, circulation data 174, media display attributes 176, and count station geo-data 178. The media display attributes 176 is a data store that contains the attributes for OOH displays 102(a), 102(b) and 102(n) and panel location data. The panel location data and media display attributes are utilized to model EOA to the components of the panel location database. Other types of demographic data may also be stored in database 171. The processor unit 130 utilizes data stored in database 171 to calculate the probability that an individual observed an OOH display. For example data obtained by satellites 180(a) and 180(b) (while only two satellites are shown, any suitable number could be used), from tracking units 140, is transmitted to processor 130 and may be stored in database 171 and later used to calculate the probability that an individual observed an OOH display. Any combination of data stored in data base 171 may be used in the probability calculation. The demographic data is used to model the type, or characteristics of individuals likely to observe the OOH display.

Processor unit 130 is also in bi-directional communication with graphical user interface (GUI) 150. GUI 150 provides a mechanism for a user to input data and view processed data. GUI 150 typically includes a monitor, LCD display unit, plasma unit or other data display unit (not shown) as well as a keyboard, trackball, mouse or other input means (not shown). The processor unit 130 may also be coupled to one or more peripheral units, for example printer unit 160. Other peripheral units may include facsimile machines, speakers, scanners and devices.

An example of one embodiment of the present invention is now described in relation to FIG. 1. An average daily traffic volume quantity through a particular count station 104 is obtained. This traffic volume quantity may be, for example, measured by the Department of Transportation. For example, this volume may be 24,000 vehicles and pedestrians for a pre-specified time interval. Since the traffic pattern included North and South bound lanes, the 24,000 value is reduced by a factor of 2 to 12,000. This traffic volume quantity is then adjusted by the load factor (# of persons per vehicle) and a factor representing the percentage of time the OOH display is visible. For example the 12,000 traffic volume is adjusted by these factors to 7,872. This 7,872 represents the OTS value. The OTS value is adjusted by a EOA factor, which may be, for example, 0.7, which provides an LTS value of 8,400. The EOA coefficient is based on a statistical analysis that only 70% (0.7) of the monitored population actually focused on the OOH display. This 0.7 value is collected by use of the video simulation techniques described above. The EOA coefficient changes based on each study. The LTS quantity is then further refined by demographic data, which is obtained from either written survey data or actual travel data obtained from survey participants. The survey travel data may also be used to extrapolate a model to generate a probability rating for a display located within a proscribed area defined by count stations. The demographic data may be used to classify a survey participant based on age, gender, or other information obtained from the survey participant.

The order of the process follows the progression of: (1) traffic data being in use to determine the OTS volume, (2) the EOA scores are modeled in to refine the gross OTS audience to a LTS audience and (3) demographics from the travel surveys (including GPS) are then used to provide demographic profiles and reach and frequency to both the OTS and LTS total audiences.

It should be noted that while a specific embodiment of the present invention has been described in relation to FIG. 1, the present invention does not require each of the components discussed in relation to FIG. 1. For example, the probability could be calculated without considering the demographic data. Similarly, the EOA coefficient could be omitted and the OTS value could be used as the LTS value (i.e. the OTS value need not be modified by the EOA to calculate the LTS value).

FIG. 2 shows a flow chart 200 of steps of an embodiment of the present invention. Flow chart 200 begins with step 202. Step 204 shows that an OOH display (identified as elements 102(a), 102(b) and 102(n), in FIG. 1) is identified. The OOH display corresponds to OOH display attributes and panel location data, as shown in step 206. Step 208 shows that each OOH display is assigned or associated with a count station(s). Typically the OOH display is assigned to one or more count stations based on the knowledge that the OOH display can be seen from the travel path that the count station identifies. A new count station can be created if required. Count stations are typically designated portions of highways, city blocks, or other paths of travel. Step 210 shows that the count station geo data (identified as element 178, in FIG. 1) is used in the assignment of each count station.

Step 212 shows that traffic volume data is generated for each count station. This data takes into account circulation data (vehicular and pedestrian) (identified as element 174, in FIG. 1), as show in step 214. Further, this data may be generated by a Department of Transportation in which the count station is located, or otherwise obtained from traffic pattern data. Each count station has a unique and specific volume of traffic data associated with it. Step 216 shows that gross OTS quantity (Average DEC) for each OOH display is obtained based on the traffic pattern volume and other factors that may modify the traffic volume data. Traffic pattern volume is determined by factors such as road type, surrounding population, major intersection, etc.

Step 218 shows that the gross LTS quantity is determined based on the OTS quantity. The OTS value is adjusted by the EOA coefficient data, shown in step 220. Separate EOA's are constructed for vehicular and pedestrian exposures. Step 222 shows that EOA coefficient data further includes an eye tracking study/model, as discussed above. Further, the EOA coefficient data may also include input data corresponding to OOH display attributes and panel location data 206.

Step 224 shows that demographic profiles are ascribed to an LTS quantity. The contribution of each demographic component will depend on market size and availability data. The sources of the demographic data include, for example, demographic travel survey data 226 (e.g. GPS/CATI), demographic survey data 228 (e.g. origin/destination and mode of travel) and various secondary transportation/travel studies 230. A further contribution to the demographic data may include the count station Geo Data 210. The demographic data may include personal information related to particular respondents such as age, income, gender, marital status, nationality, ethnicity, or other personal characteristics. This data may be used to identify markets, products or otherwise provide information to target particular segments of a population.

The demographic data are linked with travel path data. This travel path data may be obtained from GPS data or satellite data, which tracks an individual's path of travel, survey data that an individual provides, a questionnaire that an individual responds to, travel surveys, third party census, integration and modeling with traffic counts, circulation data indicating how many miles an individual traveled and mode of travel indicating whether an individual traveled by car, bus, van pool, train, bicycle, motorcycle or walked.

Step 232 shows the calculation of schedule data. This calculation is based on aggregate data to analyze various advertising schedules to produces measures of schedule efficiency. Step 234 shows that the process ends.

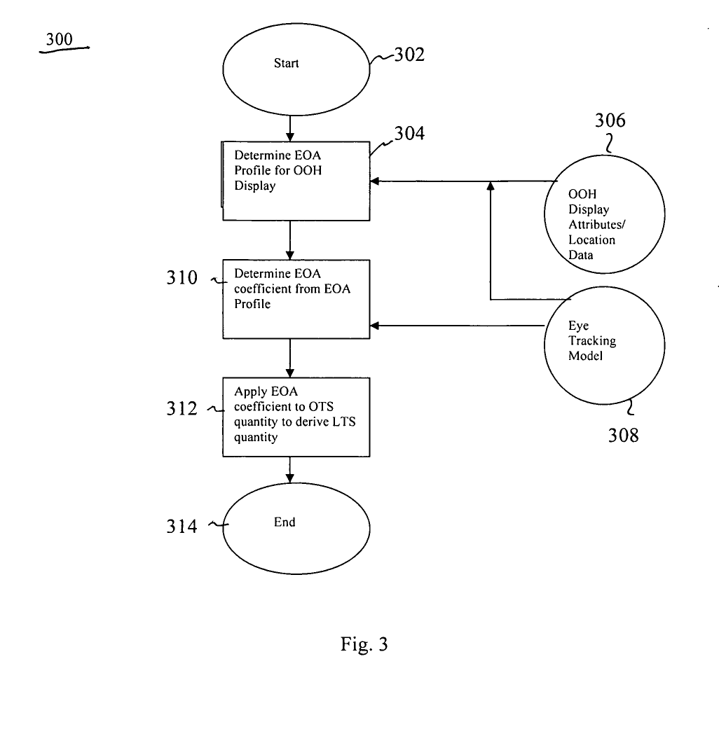

FIG. 3 shows a flowchart 300 of steps of another embodiment of the present invention. In this embodiment, the LTS quantity is derived from a EOA coefficient and an OTS quantity. Step 302 shows that the algorithm begins. Step 304 shows the step of determining a EOA profile for an OOH display. Step 306 shows that determined the EOA profile in step 304, further includes OOH display attributes and panel location data (identified as element 206, in FIG. 2). As discussed in the description of FIG. 2, the EOA includes the input of the eye tracking model 308 (identified as element 222, in FIG. 2).

Step 310 shows that a EOA coefficient is determined from the EOA profile. Step 312 shows that the EOA coefficient is applied to an OTS quantity to derive a LTS quantity, and step 320 shows that the process ends.

Although the preferred embodiment has been described in detail, it should be understood that various changes, substitutions and alterations can be made therein without departing from the spirit and scope of the invention as defined by the appended claims.

What is claimed is:

1. A method for determining a probability that a media display will be observed, the method comprising:
accessing a circulation quantity, which is a function of traffic volume through an associated geographic area;
calculating an opportunity to see quantity as a function of the circulation quantity;
calculating a likely-to-see quantity by multiplying the opportunity quantity by a predetermined coefficient; and
calculating a probability that a media display will be seen by adjusting the likely-to-see quantity by demographic data.

2. The method as recited in claim 1, further comprising:
utilizing GPS data as a component of the demographic data.

3. The method as recited in claim 1, further comprising:
utilizing survey data as a component of the demographic data.

4. The method as recited in claim 1, further comprising:
utilizing GPS data as a component of the demographic data; and
utilizing survey data as a component of the demographic data.

5. The method of claim 1, wherein the predetermined coefficient is based on observation data.

6. The method of claim 1, wherein the calculating step utilizes an extrapolation algorithm.

7. The method of claim 1, wherein the demographic data distinguishes vehicular traffic volume from non-vehicular traffic volume.

8. An apparatus comprising:
one or more one memory units;
one or more processing units, coupled to the one or more memory units, the processing unit adapted to execute program code to:
access a circulation quantity, which is a function of traffic volume through an associated geographic area;
calculate an opportunity to see quantity as a function of the circulation quantity;
calculate a likely-to-see quantity by multiplying the opportunity quantity by a predetermined coefficient; and
calculate a probability that a media display will be seen by adjusting the likely-to-see quantity by demographic data.
